(19) United States
(12) Patent Application Publication
(10) Pub. No.: US 2011/0001404 A1
(43) Pub. Date: Jan. 6, 2011

(54) APPARATUS INCLUDING LOCKING MEANS AND ENCLOSURE WITH LOCKING MEANS

(75) Inventors: Jerel Richard Lear, Holyoke, MA (US); John R. Cunningham, Rocky Hill, CT (US); Richard F. Hill, Easthampton, MA (US)

Correspondence Address: CANTOR COLBURN LLP, 20 Church Street, 22nd Floor, Hartford, CT, 06103, US

(73) Assignee: THE DURHAM MANUFACTURING COMPANY, Durham, CT (US)

(21) Appl. No.: 12/496,392

(22) Filed: Jul. 1, 2009

(51) Int. Cl. E05C 3/12; A47B 96/00; A47B 97/00

(52) U.S. Cl. 312/213; 292/213; 312/237

(57) ABSTRACT

An apparatus includes a swivel having a first flange with a first pivot on one side of a swivel pivot, and a second flange with a second pivot on an opposite side of the swivel pivot, and first, second, third and fourth rods. The first and second rods are each pivotally attached at a respective first end to the first pivot and extend outwardly therefrom. The third and fourth rods are each pivotally attached at a respective first end to the second pivot and extend outwardly therefrom. The first and third rods are respectively pivotable about the first and second pivots in a first plane, and the second and fourth rods are respectively pivotable about the first and second pivots in a second plane, wherein the first plane is parallel to the second plane.

### BACKGROUND OF THE INVENTION

The present disclosure relates generally to a locking rod arrangement, and particularly to an enclosure with a locking rod arrangement.

Metal storage cabinets include door arrangements that can be locked in the closed position using any one of a one-point, two-point or three-point locking arrangement. The one-point locking arrangement can be achieved by the door handle having a latch that engages with a stationary portion of the cabinet upon rotation of the handle with the door closed. The two-point locking arrangement can be achieved by two locking rods driven by rotation of the door handle to engage the cabinet door frame at the top and bottom of the cabinet with the door closed. The three-point locking arrangement can be achieved by combining the one-point and two-point locking arrangements. The locking rods that are driven by rotation of the door handle are typically disposed at the free edge of the door, that is, the non-hinged edge of the door, which makes them suitable for locking single panel doors having a hinged edge and a non-hinged edge, but not necessarily for locking bi-fold doors having two panels with a second centrally disposed hinge. In addition to providing improvements to advance the art of locking cabinets with bi-fold doors, embodiments disclosed herein also provide improvements to advance the art of locking cabinets with single panel doors that are used for paint storage or gun storage, for example, or for locking enclosures in general, such as a toolbox with a hinged top, for example. Accordingly, improvements in the art disclosed herein are not limited to cabinets, but extend to enclosures generally.

This background information is provided to reveal information believed by the applicant to be of possible relevance to the present invention. No admission is necessarily intended, nor should be construed, that any of the preceding information constitutes prior art against the present invention.

### BRIEF DESCRIPTION OF THE INVENTION

An embodiment of the invention is an apparatus having a swivel, a first pair of rods, and a second pair of rods. The swivel includes means for pivoting the swivel, a first flange having a first pivot on one side of the means for pivoting, and a second flange having a second pivot on an opposite side of the means for pivoting. The first pair of rods are each pivotally attached at a respective first end to the first pivot and extend outwardly therefrom. The second pair of rods are each pivotally attached at a respective first end to the second pivot and extend outwardly therefrom. The first pair of rods include first and second rods, and the second pair of rods include third and fourth rods. The first rod and the third rod are respectively pivotable about the first and second pivots in a first plane, and the second and fourth rod are respectively pivotable about the first and second pivots in a second plane, wherein the first plane is parallel to the second plane.

Another embodiment of the invention includes the foregoing apparatus further arranged having a body, a panel coupled to the body, and a handle pivotally attached to the panel. The panel is configured and disposed for being opened and closed, such that the body and panel define an interior space of an enclosure, the panel providing means for accessing the interior space. The handle includes a front portion on a front side of the panel, wherein the aforementioned swivel is rigidly connected with the front portion on a back side of the panel through an opening in the panel such that rotation of the front portion causes rotation of the swivel.

### BRIEF DESCRIPTION OF THE DRAWINGS

Referring to the exemplary drawings wherein like elements are numbered alike in the accompanying Figures:

FIG. 1 depicts a front isometric view of an enclosure in accordance with an embodiment of the invention having two sets of closed bi-fold doors;

FIG. 2 depicts another front isometric view of an enclosure in accordance with an embodiment of the invention having one set of closed bi-fold doors;

FIG. 3 depicts another front isometric view of an enclosure in accordance with an embodiment of the invention having two closed single-panel doors;

FIG. 4 depicts another front isometric view of an enclosure in accordance with an embodiment of the invention having one closed single-panel door;

FIG. 5 depicts a back isometric cutaway view of the enclosure of FIG. 1;

FIG. 6 depicts an expanded isometric view of the handles of FIGS. 1;

FIG. 7 depicts an expanded isometric view of the central portion of FIG. 5;

FIGS. 8 and 9 depict segmented planar back views of the two centrally disposed doors of FIG. 5 with locking arrangements in locked and unlocked conditions, respectively;

FIG. 10 depicts an isometric view of a locking rod assembly in accordance with an embodiment of the invention;

FIG. 11 depicts an expanded isometric view of a portion of FIG. 10;

FIG. 12 depicts an isometric view of the enclosure of FIG. 1 with the doors open;

FIG. 13 depicts a plan view of a K-shaped locking rod scheme in accordance with an embodiment of the invention;

FIG. 14 depicts a plan view of an X-shaped locking rod scheme in accordance with an embodiment of the invention;

FIG. 15 depicts an isometric view of a padlockable bracket for use in accordance with an embodiment of the invention; and

FIGS. 16 and 17 depict isometric views of alternative handle placement schemes in accordance with an embodiment of the invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

An embodiment of the invention, as shown and described by the various figures and accompanying text, provides an enclosure having a more secure locking arrangement than a one-point, two-point, or three-point locking arrangement. In an embodiment where the enclosure has only one single-panel door, or one double-panel bi-fold door, a four-point or five-point locking arrangement is disclosed. In an embodiment where the enclosure has two single-panel doors, or two bi-fold doors, an eight-point or nine-point locking arrangement is disclosed.

In addition to the disclosed enclosures, also disclosed herein is a locking rod assembly well suited for providing the aforementioned four, five, eight and nine-point locking arrangements.

While embodiments described herein depict metal storage cabinets as an example structure for practicing the disclosed invention, it will be appreciated that the disclosed invention is also applicable to other types of enclosures, such as storage chests or toolboxes, for example, and is also applicable to other types of materials, such as wood or plastic, for example.

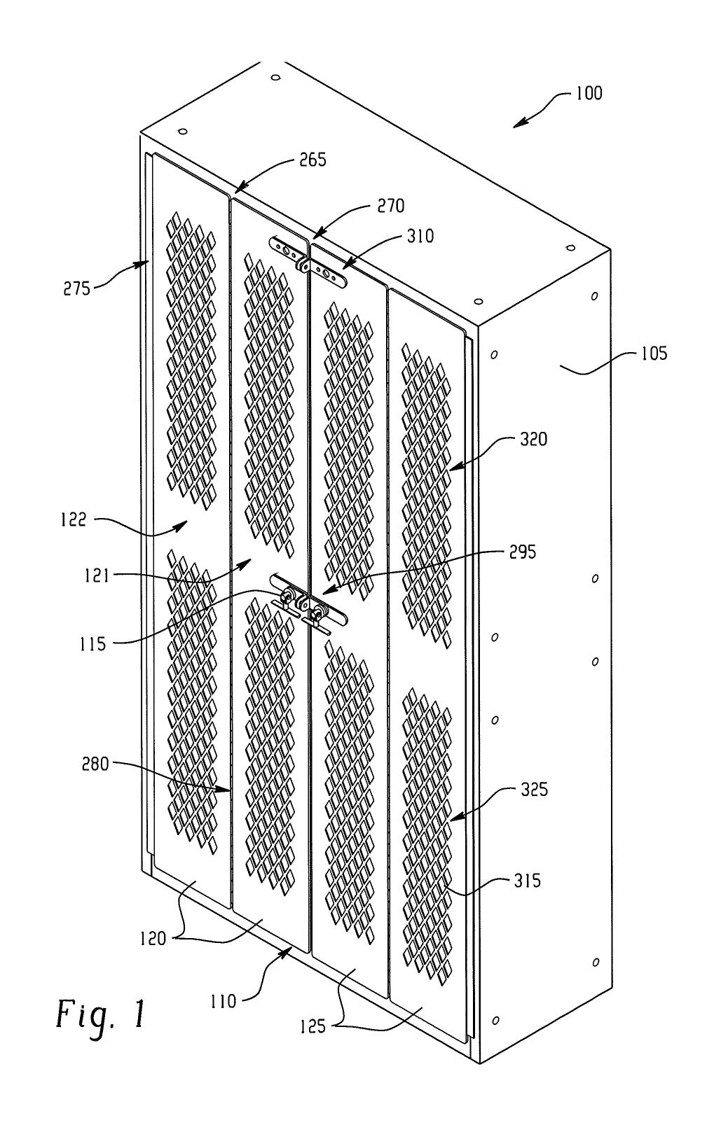

FIGS. 1-4 are example cabinets 100 in accordance with embodiments of the invention, with each cabinet 100 having a body 105, at least one panel (also herein referred to as a door) 110 coupled to the body 105 in a manner to be described further below (such as being hinged directly to the body or via a bi-fold door arrangement), and the door (panel) 110 capable of being opened and closed to provide access to an interior space of an enclosure structure defined by the body 105 and door 110. Each cabinet 100 of FIGS. 1-4 further includes a handle 115 pivotally attached to the door 110.

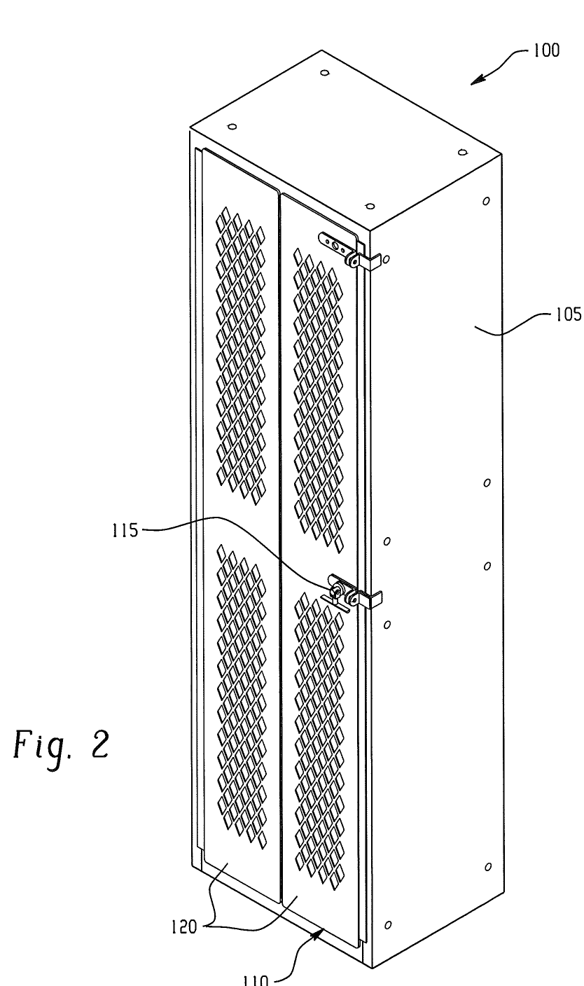

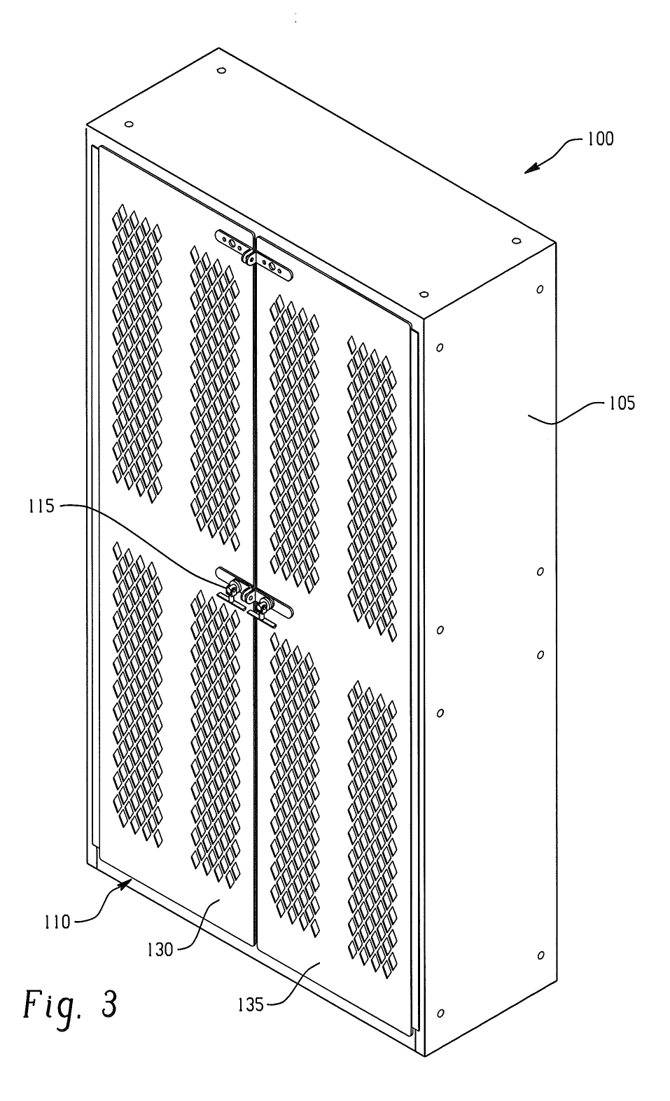

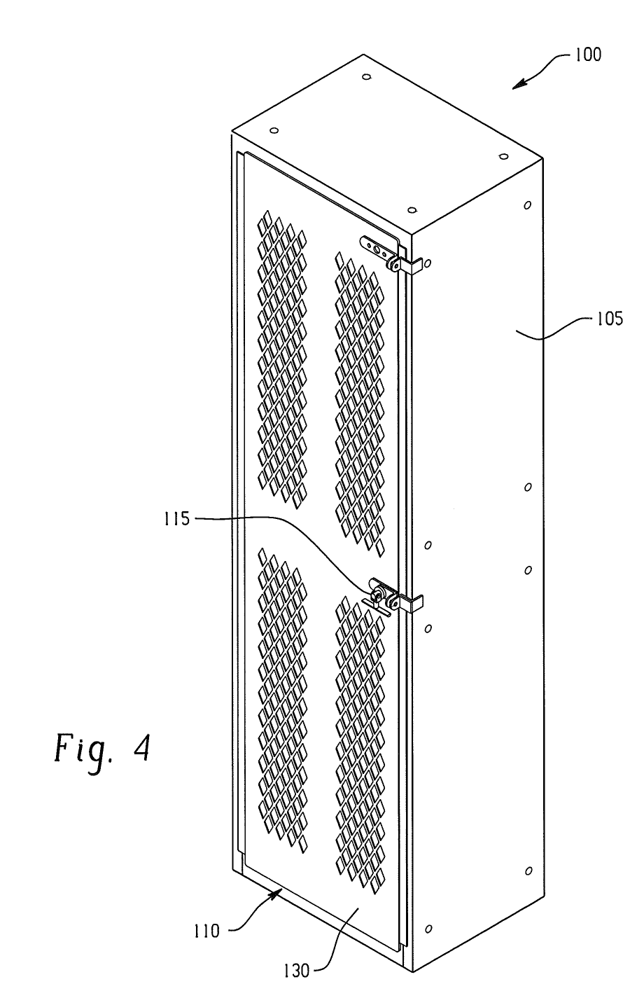

While each of the cabinets 100 depicted in FIGS. 1-4 have many similarities, they also differ by the door arrangement employed. For example; FIG. 1 depicts a cabinet 100 having two bi-fold doors 120, 125; FIG. 2 depicts a cabinet 100 having one bi-fold door 120; FIG. 3 depicts a cabinet 100 having two single-panel doors 130, 135; and FIG. 4 depicts a cabinet 100 having one single-panel door 130. As depicted by the illustrations of FIGS. 1-4, similar reference numerals are used to depict similar elements, even though they may be arranged in different ways.

From the foregoing, it will be appreciated that embodiments of the invention are not limited to a specific door arrangement, and all such door arrangements either disclosed herein or functionally equivalent thereto are considered within the scope of the invention disclosed herein. In addition, it will be appreciated from the description herein that the scope of the invention is not limited to the aesthetics of the door (flat surface, sculptured surface, or perforated surface, for example), and extends to all variations of doors (panels, tops, sides or bottoms of enclosures capable of being opened and closed) that are capable of practicing an embodiment of the invention disclosed herein.

In view of the foregoing, description of embodiments of the invention will generally proceed with discussion directed to the configuration illustrated in FIG. 1 (two bi-fold doors). However, it will be appreciated that the same discussion is equally applicable to other embodiments illustrated in FIGS. 2-4.

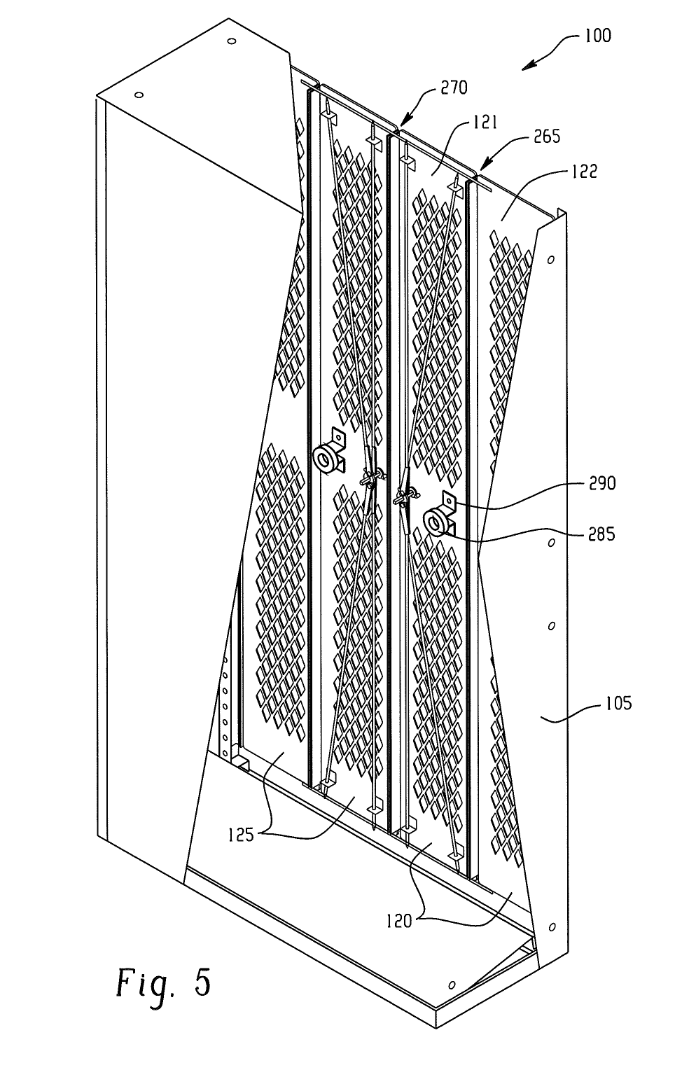

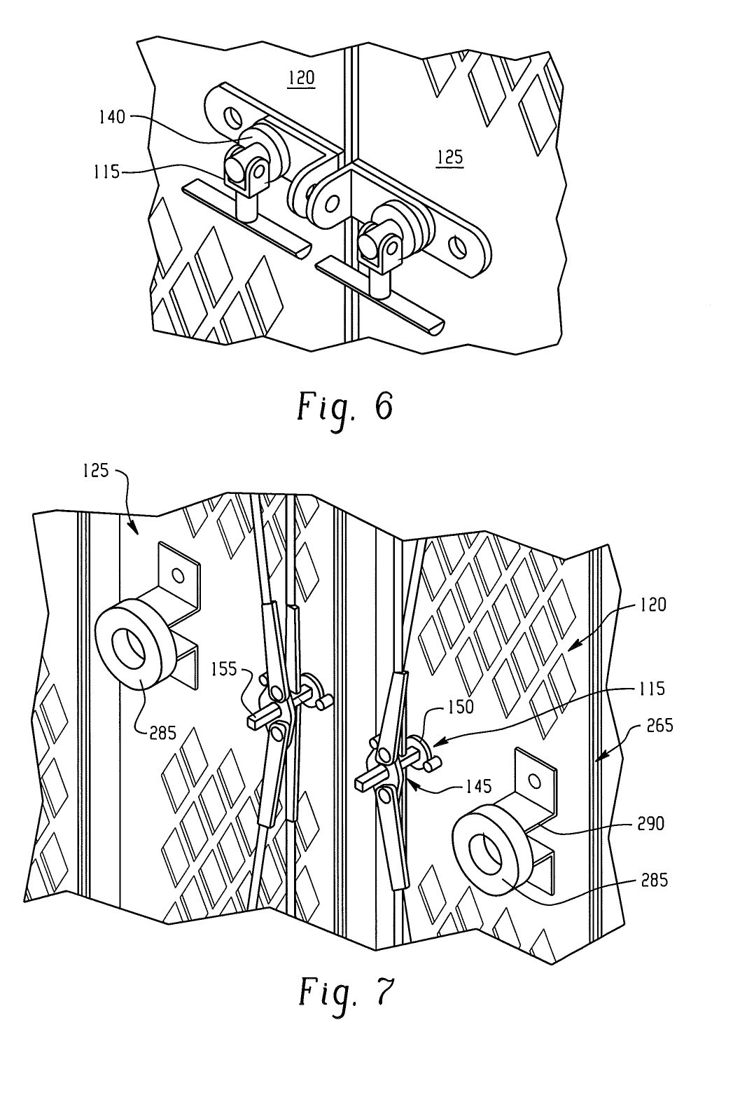

Reference is now made to FIGS. 5-7, where: FIG. 5 depicts a back isometric view of the cabinet 100 of FIG. 1 with a portion of the body 105 removed to illustrate the back side of the doors 120, 125; FIG. 6 depicts an enlarged view of the handle 115 of FIG. 1; and FIG. 7 depicts an enlarged view of the back side of handle 115 of FIG. 5. The handle 115 includes a front portion 140 on a front side of the door 120, and a swivel 145 on a back side of the door 120, where the swivel 145 is rigidly connected with the front portion 140 through an opening 150 in the door 120 via a crank 155 such that rotation of the front portion 140 causes rotation of the swivel 145.

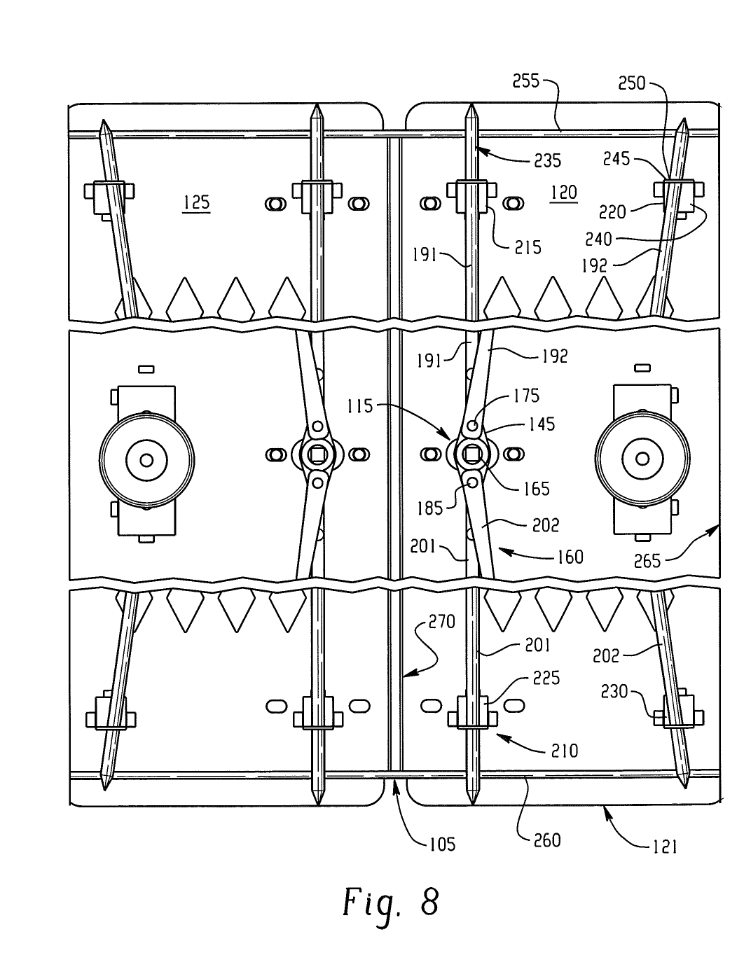

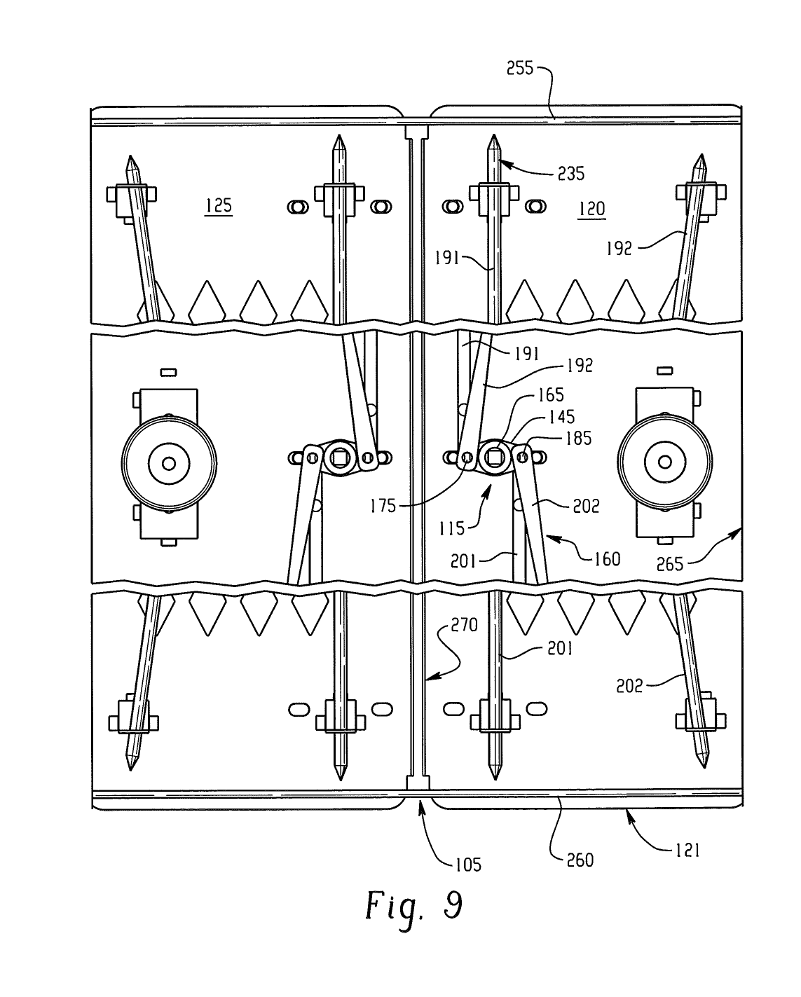

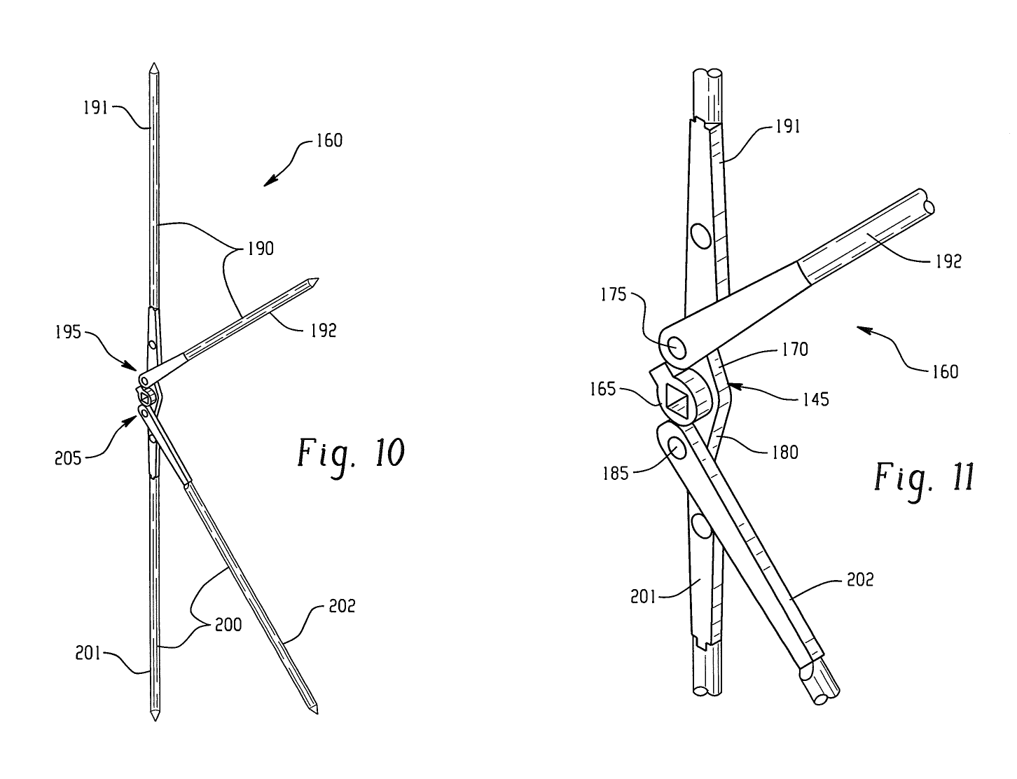

Action of the handle 115 and swivel 145 with respect to locking and unlocking of the doors 120, 125 will now be discussed with reference to FIGS. 8-11, where: FIG. 8 depicts a segmented back view of the two centrally disposed bi-fold doors 120, 125 with the handle 115 and swivel 145 in the locked position; FIG. 9 depicts a segmented back view of the two centrally disposed bi-fold doors 120, 125 with the handle 115 and swivel 145 in the unlocked position; FIG. 10 depicts an apparatus forming a locking rod assembly 160, as also depicted on bi-fold door 120 of FIGS. 8 and 9; and FIG. 11 depicts an enlarged view of locking rod assembly 160 showing more detail associated with swivel 145. As illustrated in FIGS. 10 and 11, locking rod assembly 160 includes the swivel 145 having a central pivot 165 for pivoting the swivel 145, a first flange 170 having a first pivot 175 on one side of the central pivot 165, and a second flange 180 having a second pivot 185 on an opposite side of the central pivot 165. In an embodiment, the second pivot 185 diametrically opposes the first pivot 175 on opposite sides of the central pivot 165. A first pair of locking rods 190 is disposed such that each rod is pivotally attached at a respective first end 195 to the first pivot 175 and extends outwardly therefrom. A second pair of locking rods 200 is disposed such that each rod is pivotally attached at a respective first end 205 to the second pivot 185 and extends outwardly therefrom. The first pair of locking rods 190 includes first and second rods 191, 192, and the second pair of locking rods 200 comprises third and fourth rods 201, 202, which are collectively disposed and arranged such that the first rod 191 and the third rod 201 are respectively pivotable about the first 175 and second 185 pivots in a first plane (a plane of rotation defined by the respective rods), and the second rod 192 and fourth rod 202 are respectively pivotable about the first 175 and second 185 pivots in a second plane (a plane of rotation defined by the respective rods), wherein the first plane is parallel to the second plane.

While embodiments of the locking rod assembly 160 are disclosed herein having a single swivel 145 with four rod locking rods 191, 192, 201 and 202 attached thereto, it will be appreciated that the swivel 145 may be bifurcated into two swivels (not specifically shown) having rods 191 and 201 pivotally attached to one swivel, and rods 192 and 202 pivotally attached to another swivel, in a manner similar to that illustrated herein and discussed above. Such a configuration is contemplated herein and considered within the ambit of the invention disclosed herein.

Referring back to FIGS. 8 and 9, with reference being made to the locking rod assembly 160 associated with door 120, but recognizing that the same description applies to the locking rod assembly 160 associated with door 125, or any other doors 110 of any of the figures disclosed herein, or any other openable and closable panel falling under the ambit of the disclosed invention. In an embodiment, door 120 includes a plurality of rod guides 210, including first 215, second 220, third 225 and fourth 230 rod guides fixedly attached to the back side of the door 120 at respective first, second, third and fourth corners of the door 120 (reference numerals to the corners of the door being omitted as being identifiable by reference to numerals 215, 220, 225, 230). The second end 235 of each respective first 191, second 192, third 201 and fourth 202 rod is contained by a respective one of the plurality of rods guides 210 in such a manner as to allow translational motion of the respective rod in a direction defined by a location of the handle 115 and a location of the respective rod guide on the door 120. Each of the plurality of rod guides 210 includes a first flange 240 (see reference numerals associated with second rod guide 220, FIG. 8) fixedly attached to the back side of the door 120, and a second flange 245 orthogonal to the first flange 240 and comprising a hole 250 therethrough that contains a respective one of the plurality of rods guides 210 in such a manner as to allow the aforementioned translational motion.

Locking action of the plurality of locking rods 191, 192, 201 and 202 can be seen with reference to FIGS. 8 and 9 in combination. In FIG. 8, swivel 145 is turned via handle 115 such that first and second pivots 175, 185 are vertically oriented (with respect to the illustrated orientation), which drives rods 191, 192, 201 and 202 outward away from central pivot 165 to an extended position, such that each second end 235 of each respective rod is captured behind upper and lower lips 255, 260 of the cabinet body 105, thereby locking the door 120 closed with respect to the body 105. In FIG. 9, swivel 145 is turned via handle 115 such that first and second pivots 175, 185 are horizontally oriented, which drives rods 191, 192, 201 and 202 inward toward central pivot 165 to a retracted position, such that each second end 235 of each respective rod is clear of upper and lower lips 255, 260 of the cabinet body 105, thereby allowing the door 120 to open. In an embodiment, the first 191, second 192, third 201 and fourth 202 rods each have a substantially pointed second end 235 that facilitates sliding engagement behind the upper and lower lips 255, 260 of the cabinet body 105. As can be seen with reference to at least FIGS. 8 and 9, the four locking rods 191, 192, 201 and 202 of each locking rod assembly 160 provides a four point locking scheme. As such, an eight-point locking scheme is provided with a cabinet 100 having two door panels 120, 125 with each door being equipped with a four-rod locking rod assembly 160.

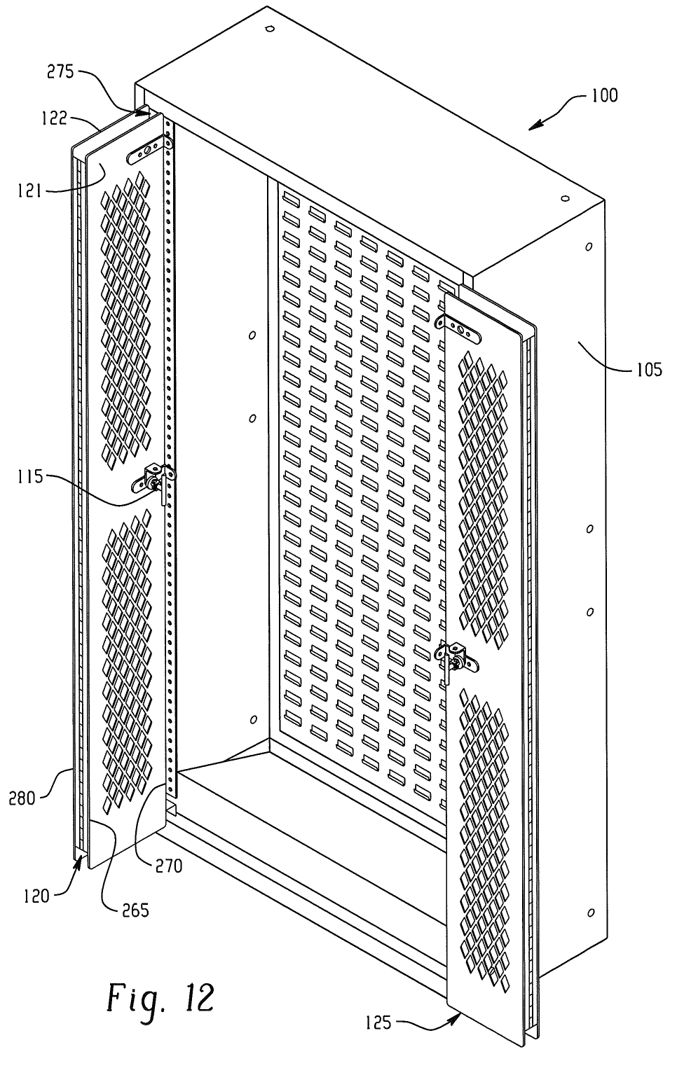

With reference now to FIGS. 1, 5, 8, 9 and 12 in combination, door 120 (illustrated as a bi-fold door) includes a first panel 121 and a second panel 122. The first panel 121 includes a hinged edge 265 and a non-hinged edge 270 parallel to the hinged edge 265. The second panel 122 includes a first hinged edge 275 hinged to the body 105, and a second hinged edge 280 parallel to the first hinged edge 275. The second hinged edge 280 of the second panel 122 is hinged to the hinged edge 265 of the first panel 121. The first panel 121 and the second panel 122 are hinged such that the second panel 122 swings outward away from the body 105 and the first panel 121 swings inward towards the body 105 when opening and folding the bi-fold door 120 (best seen by referring to FIG. 12). In an embodiment, the handle 115 and swivel 145 assembly is disposed closer to the non-hinged edge 270 than to the hinged edge 265 of the first panel 121, such that a shape formed by the first, second, third and fourth rods 191, 192, 201 and 202 relative to the swivel 145 is substantially K-shaped, which may be seen with reference to FIG. 5, but is best seen with reference to FIG. 13.

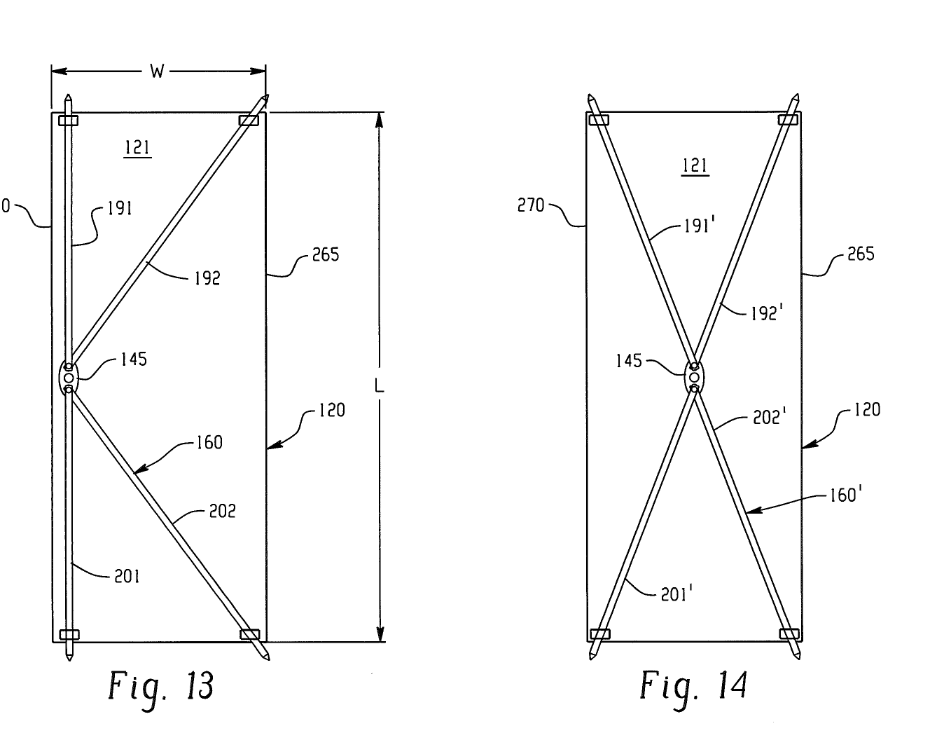

Alternative to a K-shaped locking rod assembly 160 of FIG. 13, an embodiment of the invention also includes an X-shaped locking rod assembly 160′, best seen by referring to FIG. 14. In the embodiment of FIG. 14, the handle 115 and swivel 145 assembly is disposed midway between the non-hinged edge 270 and the hinged edge 265 of the first panel 121, such that a shape formed by the first, second, third and fourth rods 191′, 192′, 201′ and 202′ relative to the swivel 145 is substantially X-shaped. In FIG. 14, reference numerals 160′, 191′, 192′, 201′ and 202′ are “primed” to distinguish them from the un-primed elements of FIG. 13 having the same base number since the lengths of the associated rods will be different owing to the placement of the handle 115 and swivel 145 assembly on the door 121. In an embodiment employing the K-shaped configuration where the handle 115 and swivel 145 are midway between the top and bottom of the door 120, at a dimension of L/2 for example, the first 191 and third 201 rods have a same first length, and the second 192 and fourth 202 rods have a same second length different from the first length, while in an embodiment employing the X-shaped configuration with similarly placed handle 115 and swivel 145, the first 191′, second 192′, third 201′ and fourth 202′ rods each have the same length.

With reference now to FIGS. 5, 7 and 12, and to facilitate holding of bi-fold doors 120, 125 in a folded position when open, a permanent magnet 285 is disposed on the back side of each first panel 121 proximate the hinged edge 265 of the first panel 121 and is sufficiently coupled to and displaced from the back side of the first panel 121 via a standoff support 290 such that the permanent magnet 285 magnetically attaches to the back side of the second panel 122 when the bi-fold door 120 is folded in a position giving access to the interior space (see left side bi-fold door 120 in FIG. 12 for example).

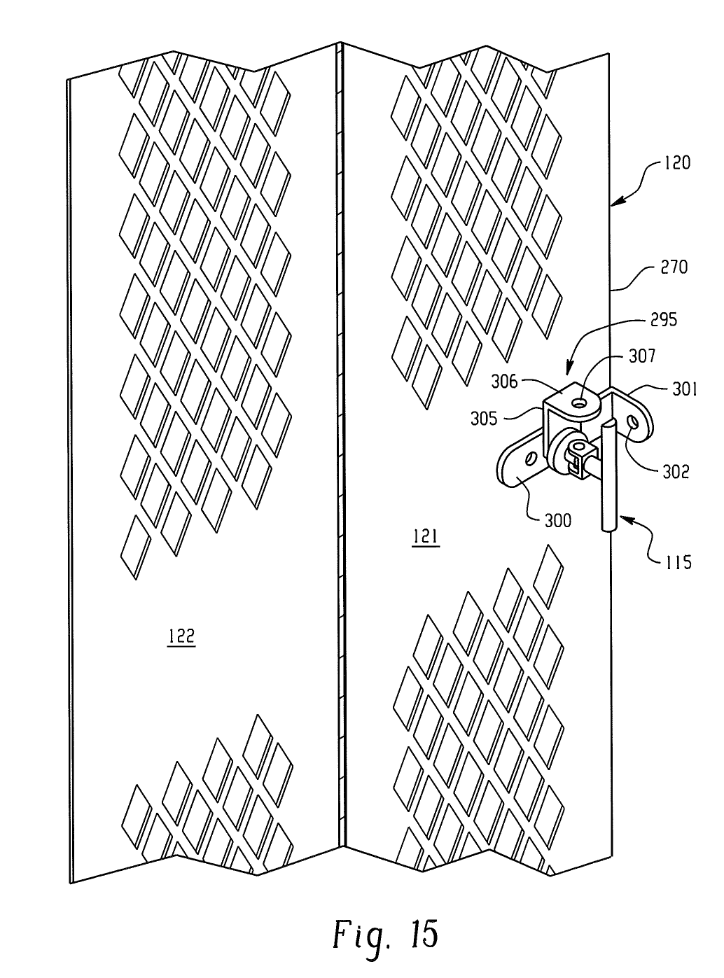

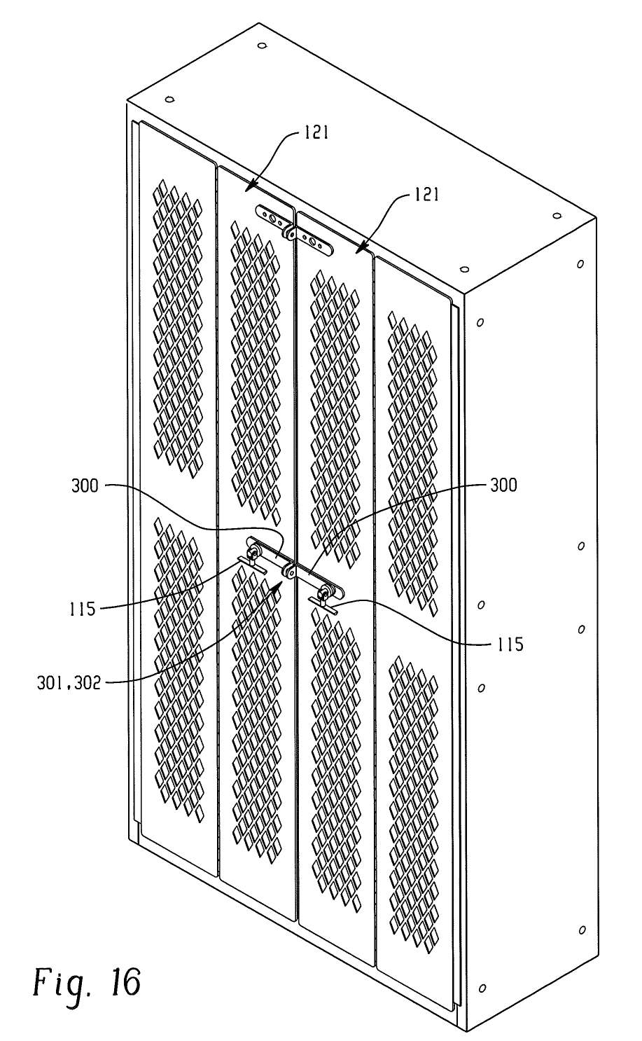

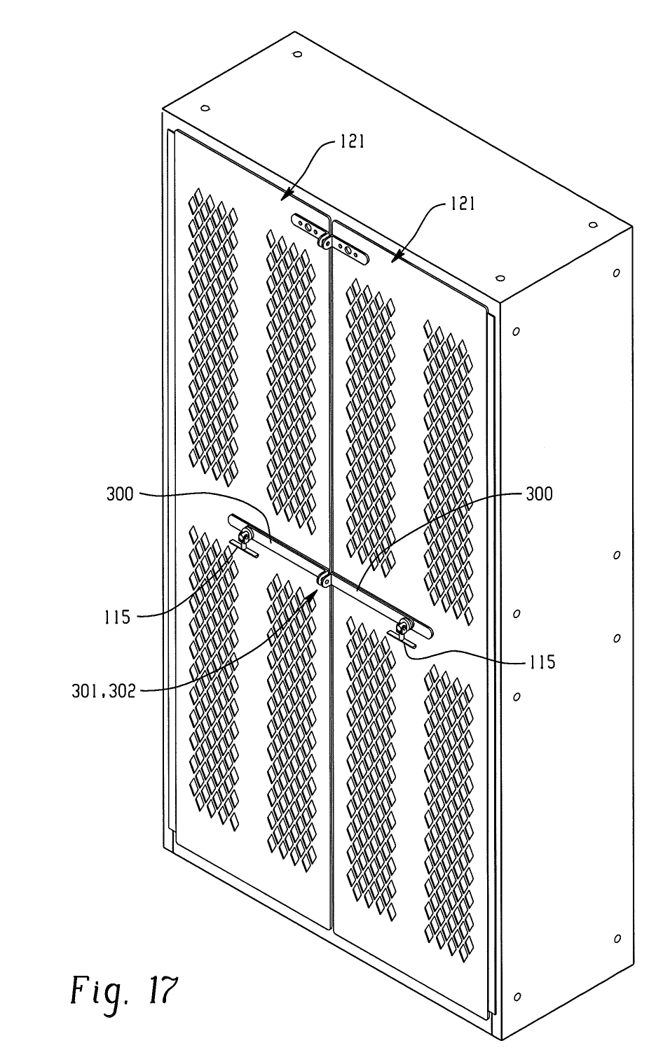

As discussed above, four-point and eight-point locking schemes are provided with a cabinet 100 having two door panels 120, 125 with each door being equipped with a four-rod locking rod assembly 160. However, by providing a padlockable bracket at the elevation of the handle 115, five-point and nine-point locking schemes may also be provided. Referring to FIG. 15, which depicts a handle 115 disposed close to the non-hinged edge 270 of first panel 121 of bi-fold door 120, an embodiment of a padlockable bracket 295 is depicted. Here, a stationary bracket 300 is fixed to the panel 121 while a rotatable bracket 305 is coupled to and rotatable with handle 115. Each bracket 300, 305 has a flange 301, 306 with a hole 302, 307 therethrough for receiving a padlock shank when the holes are lined up with the handle and the locking rods being in a closed and locked position. In an embodiment, and with reference briefly to FIG. 1, an additional padlockable bracket 310 may be employed at the top and/or bottom of the cabinet 100 (illustrated only at the top in FIG. 1) for added security. While FIGS. 1 and 15 depict a padlockable bracket 295 having both stationary 300 and rotatable 305 brackets, other embodiments, referring now to FIG. 16 (depicting bi-fold doors with centrally disposed handles, thereby providing an X-shaped locking rod scheme) and FIG. 17 (depicting single-panel doors with centrally disposed handles, thereby providing an X-shaped locking rod scheme) having the handle 115 centrally disposed between the side edges of the respective panel 121, may include only a stationary bracket 300 on each panel 121, relying solely on the flanges 301 with holes 302 of each stationary bracket 300 for receiving a padlock therethrough.

The K-shaped and X-shaped locking schemes disclosed herein are useful for providing secure locking arrangements in cabinets housing hazardous, flammable or dangerous products and/or devices, such as chemicals, paints, and guns for example. To facilitate visual access or airflow access through the doors 120, 125 to the interior space for inspection or ventilation thereof, the doors 120, 125 may include a plurality of openings 315 (see FIG. 1 for example), which in an embodiment are diamond-shaped openings. As illustrated in FIG. 1 and several of the other figures disclosed herein, an embodiment includes a first set 320 of openings 315 disposed above the elevation of handle 115, and a second set 325 of openings 315 disposed below the elevation of handle 115.

While certain combinations of single-panel doors, bi-fold panel doors, centrally disposed and non-centrally disposed handles, centrally disposed and non-centrally disposed padlockable brackets, have been described herein, it will be appreciated that these certain combinations are for illustration purposes only and that any combination of any of the foregoing structural features may be employed in accordance with an embodiment of the invention. Any and all such combinations are contemplated herein and are considered within the scope of the invention disclosed.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An apparatus, comprising:
a swivel comprising means for pivoting the swivel, a first flange comprising a first pivot on one side of the means for pivoting, and a second flange comprising a second pivot on an opposite side of the means for pivoting;
a first pair of rods each pivotally attached at a respective first end to the first pivot and extending outwardly therefrom; and
a second pair of rods each pivotally attached at a respective first end to the second pivot and extending outwardly therefrom;
wherein the first pair of rods comprises first and second rods, and the second pair of rods comprises third and fourth rods;
wherein the first rod and the third rod are respectively pivotable about the first and second pivots in a first plane;
wherein the second and fourth rod are respectively pivotable about the first and second pivots in a second plane;
wherein the first plane is parallel to the second plane.

2. The apparatus of claim 1, wherein the second pivot diametrically opposes the first pivot on opposite sides of the means for pivoting.

3. The apparatus of claim 1, wherein the first, second, third and fourth rods each have a substantially pointed second end.

4. The apparatus of claim 1, wherein the first and third rods have a same first length, and the second and fourth rods have a same second length different from the first length.

5. The apparatus of claim 1, wherein the first, second, third and fourth rods each have the same length.

6. The apparatus of claim 1, further comprising:
a body;
a panel coupled to the body and capable of being opened and closed, the body and panel defining an interior space of an enclosure, the panel providing means for accessing the interior space; and
a handle pivotally attached to the panel, the handle comprising a front portion on a front side of the panel;
wherein the swivel is rigidly connected with the front portion on a back side of the panel through an opening in the panel such that rotation of the front portion causes rotation of the swivel.

7. The apparatus of claim 6, further comprising:
a plurality of rod guides fixedly attached to the back side of the panel;
wherein the second end of each respective first, second, third and fourth rod is contained by a respective one of the plurality of rods guides in such a manner as to allow translational motion of the respective rod in a direction defined by a location of the handle and a location of the respective rod guide on the panel.

8. The apparatus of claim 7, wherein:
the plurality of rod guides comprises first, second, third and fourth rod guides each comprising a first flange fixedly attached to the back side of the panel, and a second flange orthogonal to the first flange and comprising a hole therethrough that contains a respective one of the plurality of rods guides in such a manner as to allow translational motion of the respective rod in a direction defined by a location of the handle and a location of the respective rod guide on the panel.

9. The apparatus of claim 7, wherein:
the panel comprises a hinged edge and a non-hinged edge parallel to the hinged edge, the panel being hinged to the body at the hinged edge;
the handle is disposed closer to the non-hinged edge than to the hinged edge;
the panel comprises four corners;
the first rod guide is disposed toward the first corner of the panel, the second rod guide is disposed toward the second corner of the panel, the third rod guide is disposed toward the third corner of the panel, and the fourth rod guide is disposed toward the fourth corner of the panel, such that a shape formed by the first, second, third and fourth rods relative to the swivel is substantially K-shaped.

10. The apparatus of claim 7, wherein:
the panel comprises a hinged edge and a non-hinged edge parallel to the hinged edge, the panel being hinged to the body at the hinged edge;
the handle is disposed midway between the non-hinged edge and the hinged edge;
the panel comprises four corners;
the first rod guide is disposed toward the first corner of the panel, the second rod guide is disposed toward the second corner of the panel, the third rod guide is disposed toward the third corner of the panel, and the fourth rod guide is disposed toward the fourth corner of the panel, such that a shape formed by the first, second, third and fourth rods relative to the swivel is substantially X-shaped.

11. The apparatus of claim 7, wherein the panel defines a first panel, and further comprising a second panel hinged to the first panel to form a bi-fold door arrangement with respect to the body, wherein:
the second panel comprises a first hinged edge and a second hinged edge parallel to the first hinged edge, the second panel being hinged to the body at the first hinged edge;
the first panel comprises a hinged edge and a non-hinged edge parallel to the hinged edge, the hinged edge of the first panel being hinged to the second hinged edge of the second panel;
the handle is disposed closer to the non-hinged edge than to the hinged edge of the first panel;
the first panel comprises four corners;
the first rod guide is disposed toward the first corner of the first panel, the second rod guide is disposed toward the second corner of the first panel, the third rod guide is disposed toward the third corner of the first panel, and the fourth rod guide is disposed toward the fourth corner of the first panel, such that a shape formed by the first, second, third and fourth rods relative to the swivel is substantially K-shaped;
the first panel and the second panel being hinged such that the second panel swings outwards away from the body, and the first panel swings inwards towards the body when opening and folding the bi-fold door.

12. The apparatus of claim 7, wherein the panel defines a first panel, and further comprising a second panel hinged to the first panel to form a bi-fold door arrangement with respect to the body, wherein:
the second panel comprises a first hinged edge and a second hinged edge parallel to the first hinged edge, the second panel being hinged to the body at the first hinged edge;
the first panel comprises a hinged edge and a non-hinged edge parallel to the hinged edge, the hinged edge of the first panel being hinged to the second hinged edge of the second panel;
the handle is disposed midway between the non-hinged edge and the hinged edge of the first panel;
the first panel comprises four corners;
the first rod guide is disposed toward the first corner of the first panel, the second rod guide is disposed toward the second corner of the first panel, the third rod guide is disposed toward the third corner of the first panel, and the fourth rod guide is disposed toward the fourth corner of the first panel, such that a shape formed by the first, second, third and fourth rods relative to the swivel is substantially X-shaped;
the first panel and the second panel being hinged such that the second panel swings outwards away from the body, and the first panel swings inwards towards the body when opening and folding the bi-fold door.

13. The apparatus of claim 9, wherein:
the panel comprises a length dimension and a width dimension orthogonal thereto, the width dimension being from the hinged side to the non-hinged side;
the handle is disposed at a midpoint of the length dimension.

14. The apparatus of claim 10, wherein:
the panel comprises a length dimension and a width dimension orthogonal thereto, the width dimension being from the hinged side to the non-hinged side;
the handle is disposed at a midpoint of the length dimension.

15. The apparatus of claim 11, wherein:
the panel comprises a length dimension and a width dimension orthogonal thereto, the width dimension being from the hinged side to the non-hinged side;
the handle is disposed at a midpoint of the length dimension.

16. The apparatus of claim 12, wherein:
the panel comprises a length dimension and a width dimension orthogonal thereto, the width dimension being from the hinged side to the non-hinged side;
the handle is disposed at a midpoint of the length dimension.

17. The apparatus of claim 11, further comprising:
a permanent magnet disposed on the back side of the first panel proximate the hinged edge of the first panel and being sufficiently coupled to and displaced from the back side of the first panel such that the permanent magnet magnetically attaches to the back side of the second panel when the bi-fold door is folded in a position giving access to the interior space.

18. The apparatus of claim 12, further comprising:
a permanent magnet disposed on the back side of the first panel proximate the hinged edge of the first panel and being sufficiently coupled to and displaced from the back side of the first panel such that the permanent magnet magnetically attaches to the back side of the second panel when the bi-fold door is folded in a position giving access to the interior space.

19. The apparatus of claim 6, wherein the panel comprises a plurality of diamond-shaped openings arranged in two sets that provide visual access through the panel to the interior space and airflow access through panel to the interior space, a first of the two sets being disposed above the handle, and a second of the two sets being disposed below the handle.

20. The apparatus of claim 10, wherein:
the panel comprises a first means for receiving a padlock disposed at an upper outside corner of the non-hinged side, and a second means for receiving a padlock disposed between the upper outside corner and a lower outside corner of the non-hinged side at a same elevation as that of the handle.
